(19) United States
(12) Patent Application Publication
(10) Pub. No.: US 2019/0011818 A1
(43) Pub. Date: Jan. 10, 2019

(54) Special Light Effects by Laser Light Source

(71) Applicant: Tseng-Lu Chien, Walnut, CA (US)

(72) Inventor: Tseng-Lu Chien, Walnut, CA (US)

(21) Appl. No.: 16/128,049

(22) Filed: Sep. 11, 2018

Related U.S. Application Data
(63) Continuation-in-part of application No. 14/844,314, filed on Sep. 3, 2015.
Application No. 14/844,314 is a continuation of application No. 12/938,564, filed on Nov. 3, 2010, now Pat. No. 9,239,513.
Application No. 12/938,564 is a continuation-in-part of application No. 15/170,071, filed on Jun. 1, 2016.
Application No. 15/170,071 is a continuation-in-part of application No. 14/844,314, filed on Sep. 3, 2015.
Application No. 14/844,314 is a continuation-in-part of application No. 12/938,564, filed on Nov. 3, 2010, now Pat. No. 9,239,513.
Application No. 12/938,564 is a continuation-in-part of application No. 12/866,832, filed on Aug. 9, 2010, now abandoned.
Application No. 12/866,832 is a continuation-in-part of application No. 12/624,621, filed on Nov. 24, 2009, now Pat. No. 8,303,150.
Application No. 12/624,621 is a continuation-in-part of application No. 14/023,889, filed on Sep. 11, 2013.
Application No. 14/023,889 is a continuation-in-part of application No. 12/938,564, filed on Nov. 3, 2010, now Pat. No. 9,239,513.

(51) Int. Cl. G03B 21/20; F21V 23/06; F21V 23/04; F21L 4/00; F21Y 115/10; F21Y 115/30

(52) U.S. Cl. CPC G03B 21/20; G03B 21/2086; F21V 23/06; F21Y 2115/30; F21L 4/00; F21Y 2115/10; F21V 23/0471

(57) ABSTRACT

The special effects of laser light source is to change laser spot light-beam to area or surface or elongate light illumination which can make wide or long area or surface be illuminated for very closely brightness or other effects. The said special effects are shown on the products housing or parts not outside the products. Or the special laser light effects is made by (1) more than one level grating-piece to change the lighted patterns, or (2) more than one of the grating-piece install in one roller, disc, or holder to rotating to change the light patterns with rotating or fixed one or more optics-lens to project the laser lighted image, patterns to outside surface for indoor or outdoor application to get power from built-in prong, AC plug-wire, USB ports, connector, adaptor, or power input-ends.

The current invention is CIP filed case of

U.S. Ser. No. 15/170,071, filed on Jun. 1, 2016, Public number 2017-032-9211 on date Nov. 16, 2017, (#XX-2) which is CIP of
U.S. Ser. No. 14/844,314, filed on Sep. 3, 2015, (#XX-1) which is CIP of
U.S. Ser. No. 12/938,564, filed on Nov. 2, 2010, (#XX-2010) now is U.S. Pat. No. 9,239,513, which is CIP of
U.S. Ser. No. 12/866,832, filed on Sep. 21, 2010, which is CIP of
U.S. Ser. No. 12/624,621, filed on Nov. 24, 2009, now is U.S. Pat. No. 8,303,150, which is CIP of
U.S. Ser. No. 14/280,865, filed on May 19, 2014, now is U.S. Pat. No. 9,581,299, which is CIP of
U.S. Ser. No. 15/503,647, filed on Oct. 1, 2014, now is U.S. Pat. No. 9,719,654, which is CIP of
U.S. Ser. No. 14/023,889, filed on Sep. 11, 2013, which is CIP of
U.S. Ser. No. (#XX-2010) 12/938,564 which is filed on Nov. 2, 2010, publication number 2012-010-5814, now is U.S. Pat. No. 9,239,513 issued date Jan. 19, 2016.

### BACKGROUND

The current invention is not same as co-inventor prior-arts to use hologram or grating film or piece within or apply to the housing incorporated with LED light source(s) to form the colorful shaped image to viewer. The co-inventor related Laser technical including US Series or patent number as below:

U.S. Ser. No. 385,122 filed on Feb. 7, 1995, Now is U.S. Pat. No. 5,667,736 issued on Sep. 16, 1997 “Method of making a laser generated lighting fixture”.
U.S. Ser. No. 12/318,473 filed on Dec. 30, 2008, now is U.S. Pat. No. 7,832,918 issued on Nov. 16, 2010 “LED night light has laser or hologram element(s).
U.S. Ser. No. 12/292,153 filed on Nov. 12, 2008, now is U.S. Pat. No. 7,871,192 issued on Jan. 18, 2011 “LED night light has projection or image features”.
Those co-inventor shown the Image is shown on the film or grating film surface with colored and shaped. Not like current invention to show the Laser light beam on the outside housing or parts.

The Laser light source in market available type has different wattage or power with different wave length to desired brightness and colors including the Red color which has wave length around 650 nm or Green color which has wave length around 520 nm, or blue color which has wave length 450 nm, or blue & purple color which has wave length around 405 nm, or other desire colors or combination colors.

The Laser light source has different power output which basing on the wattage or mini-wattage for desired application such as lower power for laser point application which may only less than 0.5 mw, or some higher brightness which around less 30 mw, or some is higher power for longer distance less than 540 mw, or other different wattage for different application from laser pointer, laser patterns or image projection for indoor or outdoor night light, projection light, garden light, light-string, land-scape light, patio light, seasonal light-string, holiday light-set, radar sensing light device, motion sensor light device, power fail light, or other light applications including but not limited for following issued or co-pending filed cases;

U.S. Ser. No. 15/170,071, filed on Jun. 1, 2016, Public number 2017-032-9211 on date Nov. 16, 2017, (#XX-2) which is CIP of
U.S. Ser. No. 14/844,314, filed on Sep. 3, 2015, (#XX-1) which is CIP of
U.S. Ser. No. 12/938,564, filed on Nov. 2, 2010, (#XX-2010) now is U.S. Pat. No. 9,239,513, which is CIP of
U.S. Ser. No. 12/866,832, filed on Sep. 21, 2010, which is CIP of
U.S. Ser. No. 12/624,621, filed on Nov. 24, 2009, now is U.S. Pat. No. 8,303,150, which is CIP of
U.S. Ser. No. 14/280,865, filed on May 19, 2014, now is U.S. Pat. No. 9,581,299, which is CIP of
U.S. Ser. No. 15/503,647, filed on Oct. 1, 2014, now is U.S. Pat. No. 9,719,654, which is CIP of
U.S. Ser. No. 14/023,889, filed on Sep. 11, 2013, which is CIP of
U.S. Ser. No. (#XX-2010) 12/938,564 which is filed on Nov. 2, 2010, publication number 2012-010-5814, now is U.S. Pat. No. 9,239,513 issued date Jan. 19, 2016.
The current invention also is CIP or Division filed case as below:
This is Division filing for
(#FF-4) U.S. application Ser. No. 14/967,862 filed on which is CIP for filing of
(#FF-3) U.S. application Ser. No. 14/539,027 filed on which is CIP for filing of
(#FF-2) U.S. application Ser. No. 14/275,184 filed on which is CIP for filing of
(#FF-1) U.S. application Ser. No. 12/886,832 filed on Sep. 21, 2010 now is U.S. Pat. No. 8,721,160 which is CIP for filing of
(#FF-2008) U.S. application Ser. No. 12/318,470 filed on Dec. 30, 2008 now abandoned, which is Division for filing of which is Division for filing of
(#Q-2007) U.S. application Ser. No. 11/806,284 Filed on Dec. 15, 2007 now is U.S. Pat. No. 7,630,004
This filing is Division filing of
(#ZZZ-4) U.S. application Ser. No. 14/296,599 Filed on Oct. 18, 2016 which is Continue In Part filing of
(#ZZZ-3) U.S. application Ser. No. 14/503,647 filed on Oct. 1, 2014 now is U.S. Pat. No. 9,719,654 which is Division filing of
(#ZZZ-2) U.S. application Ser. No. 14/451,822 filed on Aug. 5, 2014, which is Continue In Part filing of
(#ZZZ-1) U.S. application Ser. No. 14/323,318 filed on Jul. 3, 2014 which is Continue In Part filing of
(#ZZZ-13) U.S. application Ser. No. 14/023,889 filed on Sep. 11, 2013.
Related to the wider area image or project image night light or LED bulb or AC plug wire LED outdoor light with or without motor/spin/rotating kits for moving image.
This filing is Division filing of
(#QQQ-7) U.S. application Ser. No. 15/494,477 filed on Apr. 24, 2017
which is continue in part of
(#QQQ-6) U.S. application Ser. No. 15/355,515 filed on Nov. 18, 2016 which is continue in part of
(#QQQ-5) U.S. application Ser. No. 15/341,782 filed on Nov. 2, 2016 which is continue in part of
(#QQQ-4) U.S. application Ser. No. 15/348,218 filed on Nov. 10, 2016
which is continue in part of
(#QQQ-3) U.S. application Ser. No. 14/983,993 filed on Dec. 30, 2015
Now is allowanced which is continue in part of
(#QQQ-2) U.S. application Ser. No. 14/289,968 filed on May 29, 2014
Now is U.S. Pat. No. 9,551,477 which is continue in part of
(#QQQ-1) U.S. application Ser. No. 14/280,865 filed on May 19, 2014
Now is U.S. Pat. No. 9,581,299 which is continue in part of
(#QQQ-2012) U.S. application Ser. No. 13/540,728 filed on Jul. 3, 2012 now is U.S. Pat. 8,834,009 which is Division filed of
(#JJJ-1) U.S. application Ser. No. 13/296,469 Filed on Nov. 15, 2011 now is U.S. Pat. 8,711,216

This filing is Division filing of

(#JJJ-1) U.S. application Ser. No. 14/049,427 Filed May 22, 2014, now is U.S. Pat. No. 9,010,986 Apr. 21, 2015 issued, which is continue filing of
(#JJJ-11) U.S. application Ser. No. 13/296,508 Filed on Nov. 15, 2011. Now is U.S. Pat. No. 8,562,158 issued on Oct. 22, 2013.
Related the LED bulb has built-in Camera and storage-kits with multiple functions to replay, see by wired or wireless.

The current invention is Division or continuously filing for

(#AAA-1) U.S. application Ser. No.
which is Continue in Part of
(#AAA) U.S. application Ser. No. 12/984,583, Filed on Now
is U.S. Pat. No. 9,157,589 which is Continue in Part of
(#TT-2) U.S. application Ser. No. 14/968,250, Filed on Dec. 14, 2015
which is Continue in Part of
(#TT-1) U.S. application Ser. No. 14/944,953 Filed on Nov. 18, 2015
which is Continue in Part of
(#TT-12) U.S. application Ser. No. 12/866,832, Filed on Sep. 21, 2010
This is Division filing for
Related to the wider area image or project image night light or LED bulb or AC plug wire LED outdoor light with or without motor/spin/rotating kits for moving image.
This is Division filing for
(#II-2) U.S. application Ser. No. 13/540,689 filed on Jul. 3, 2012. Publication data US 2012-026-8668 dated on Oct. 25, 2012, Now is U.S. Pat. No. 8,511,877 issued date Aug. 20, 2013 v.s. Current parent parent (#QQQ-2012) U.S. application Ser. No. 13/540,728 filed on Jul. 3, 2012 now is U.S. Pat. No. 8,834,009 and (#ZZZ-2013) U.S. application Ser. No. 14/023,889 filed on Sep. 11, 2013 Now still pending. Which (#II-2) cover for all seasonal garden light and outdoor lighting.
This is continue in part of
(#II-1) U.S. application Ser. No. 13/534,611 filed on Jun. 27, 2012, publication data US 2012/026-8947 dated on Oct. 25, 2012, now is U.S. Pat. No. 8,714,799 issued date May 6, 2014 v.s. Current parent parent (#QQQ-2012) U.S. application Ser. No. 13/540,728 filed on Jul. 3, 2012 now is U.S. Pat. No. 8,834,009 and (#ZZZ-2013) U.S. application Ser. No. (#ZZZ-2013) U.S. application Ser. No. 14/023,889 filed on Sep. 11, 2013 now still pending. Which (#II-1) cover for all seasonal garden light and outdoor lighting.
This is continue in part of
(#II-2009) U.S. application Ser. No. 12/624,621 filed on Nov. 24, 2009, publication data US2010/0214541 date Aug. 26, 2010, now is U.S. Pat. No. 8,303,150 Issued on Nov. 6, 2012 v.s. Current parent parent (#QQQ-2012) U.S. application Ser. No. 13/540,728 filed on Jul. 3, 2012 now is U.S. Pat. No. 8,834,009 and (#ZZZ-2013) U.S. application Ser. No. (#ZZZ-2013) U.S. application Ser. No. 14/023,889 filed on Sep. 11, 2013 now still pending. Now still pending. Which (#II-2009) cover for all seasonal garden light and outdoor lighting.
This is Division filing for
(#HH-09) U.S. application Ser. No. 12/622,200 filed on Nov. 19, 2009, Publication data US 2010-102-8497 date on May 27, 2010 now is U.S. Pat. No. 8,434,927 issued date May 7, 2013 v.s. Current parent (#QQQ-2012) U.S. application Ser. No. 13/540,728 filed on Jul. 3, 2012 now is U.S. Pat. No. 8,834,009 and (#ZZZ-2013) U.S. application Ser. No. (#ZZZ-2013) U.S. application Ser. No. 14/023,889 filed on Sep. 11, 2013 now still pending. Now still pending. Which (#II-2009) cover for all seasonal garden light and outdoor lighting.
This is Division filing for
(#FF-4) U.S. application Ser. No. 14/968,862, Filed on Dec. 14, 2015
which is Continue in Part of
(#FF-3) U.S. application Ser. No. 14/539,267, Filed on Nov. 12, 2014
which is Continue in Part of
(#FF-2) U.S. application Ser. No. 14/275,184, Filed on May 12, 2014
which is Continue in Part of
(#FF-1) U.S. application Ser. No. 12/914,584, Filed on Oct. 28, 2010
now is U.S. Pat. No. 8,721,160,
In addition, the following U.S. patents show light devices having some features that are similar to and some that are different from the current invention:
The current invention mainly to apply desired combination of parts to make special illumination by laser light-source to make the spot-light laser light-beam to become big-area or long-length or big-surface light-effects which has very similar brightness on desired locations, areas, segment, parts of the desired surface, elongate length, areas. Simple word is change laser light-beam to surface or area light for even brightness.
The current invention has desired combination to make special illumination by laser light source that can change spot-light to surface or area light with closely brightness may not very evenly but at least can accepted for evenly brightness by apply or selected following desired combinations for selected-parts including:
(a) Laser light source with its trigger circuit or circuit-board, or-and
(b) Optics-lens or optics-elements including lens or element, film, piece, glass with optics-properties for magnify, grating, split, divide the laser-light beam, or-and
(c) Coiled or folded or twisted or multiple-levels or multiple-piece of light passable piece including but not limited selected from plastic-sheet, film, piece to make laser spot light-beam into lighted-area or surface or elongate length, or-and
(d) Outside housing with desired treatment, texture, colored, opaque, milky, polished and show the lighted-area or lighted-surface or lighted-elongate length or-and
(e) End cap or closing top or sealed housing to prevent laser light-beam emit out, and shown on the housing, areas, surface, elongate-length, or-and
(f) All kind of Trigger, switch, sensors, radar sensor, motion sensor, PIR sensor, RF transmitter and receiver, photo sensor to turn on and turn off, and incorporated with the IC, Circuitry, circuit-board, AC-to-DC circuit, DC-to-DC circuit, or outside transformer power system, or other power system including AC or DC or USB power source; to make the said laser light source for pre-determined brightness, color(s), time period, functions, light effects to make selection, fixed, changeable, selectable extra features.
   The current invention make special illumination of laser light source to get desired lighted-area or lighted-surface or lighted-elongate length.
   The current invention is CIP of the above list for (#XX-2010) and (#XX-1=2015 filed on Sep. 3, 2015) and (#XX-2016 filed on Jun. 1, 2016) which is 5 years earlier than below list laser light device, so those should belong invalid USA patents including;
   As for LASER PROJECT OUTDOOR LIGHT U.S. patents:
   U.S. Pat. No. 9,458,994 U.S. Ser. No. 14/976,202 filed on Dec. 21, 2015 and
   U.S. Pat. No. 9,546,775 U.S. Ser. No. 15/142,789 filed on Apr. 29, 2016, issued on Jan. 17, 2017
   U.S. Pat. No. 9,752,761 U.S. Ser. No. 15/001,942 filed on Jan. 20, 2016, issued on Sep. 5, 2017
   U.S. Ser. No. 14/958,667 Dec. 3, 2015 filed, and
   U.S. Ser. No. 14/958,657 Dec. 1, 2015 filed.
   All these related Laser outdoor project light which is 5 years later filed than current inventor's (#TT-Family) 2010 filed and (#XX-2010) filed.

Furthermore, below US issued patent which also is later than current inventor's co-pending patents for some LED project light applications.

As for the a lot of later file filed patents which should belong to invalid patents basing on all prior art study examiner did not review the all co-inventor's earlier public or issued patent data and each invalid patents has same of the all co-inventor's same concept and scope and construction and idea and should not granted patents at all including
U.S. Pat. No. 9,068,726 U.S. Ser. No. 12/079,628 filed on Nov. 13, 2013,
U.S. Pat. No. 9,194,551 U.S. Ser. No. 14/337,662 filed on Jul. 22, 2014
U.S. Pat. No. 9,395,608 U.S. Ser. No. 14/341,345 filed on Jul. 25, 2014
Which is later than current inventor's filed (#ZZ-family) on Sep. 3, 2013 or
Later than co-inventor (#TT-family) on 2010, (#II-Family) on 2009, (#FF-Family) on 2008

### BRIEF DRAWING

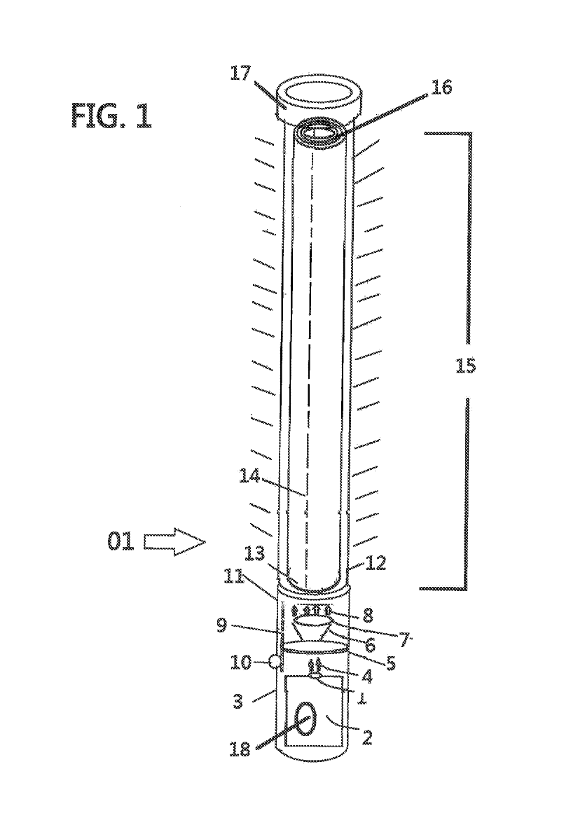

1. FIG. 1 show the 1^{st} embodiment which has elongate housing with desired length from 1 inch to 10 feet which can very close even brightness along the whole elongate length without the laser strong lighted and rest length with very dim light illumination.

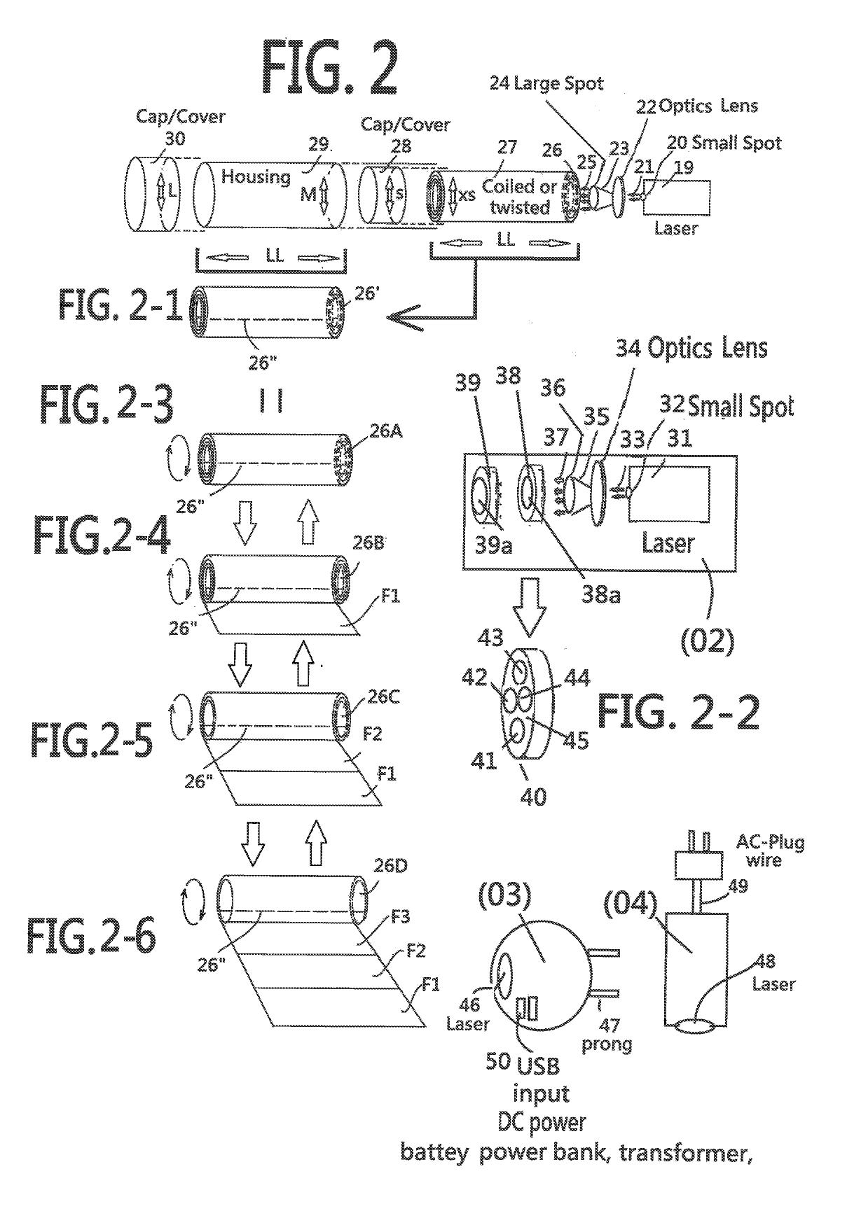

2. FIG. 2 show the detail parts and how to assembly into a elongate length for very close even brightness along the very long length which is not possible for LED light can do for 360 special light effects along whole long products housing from 1 inch to 10 or more feet.

3. FIG. 2-1 show the inner coiled or wrapped or twisted light passable material in sheet, or roll, or twisted in geometric shape so can spread out laser spot light beam to all direction to get even brightness after multiple time reflected, refraction, diffusion, random optics procedures.

4. FIGS. 2-3, 2-4, 2-5, 2-6 and FIGS. 5, 5A shown how to make inner coiled, wrapped, twisted, or other geometric shape for light passable piece, sheet, layer so can spread out the strong laser spot light into all direction even brightness special light illumination and glow the whole geometric housing for whole unit illumination with very close evenly brightness without super bright spot laser light can be seen by viewer.

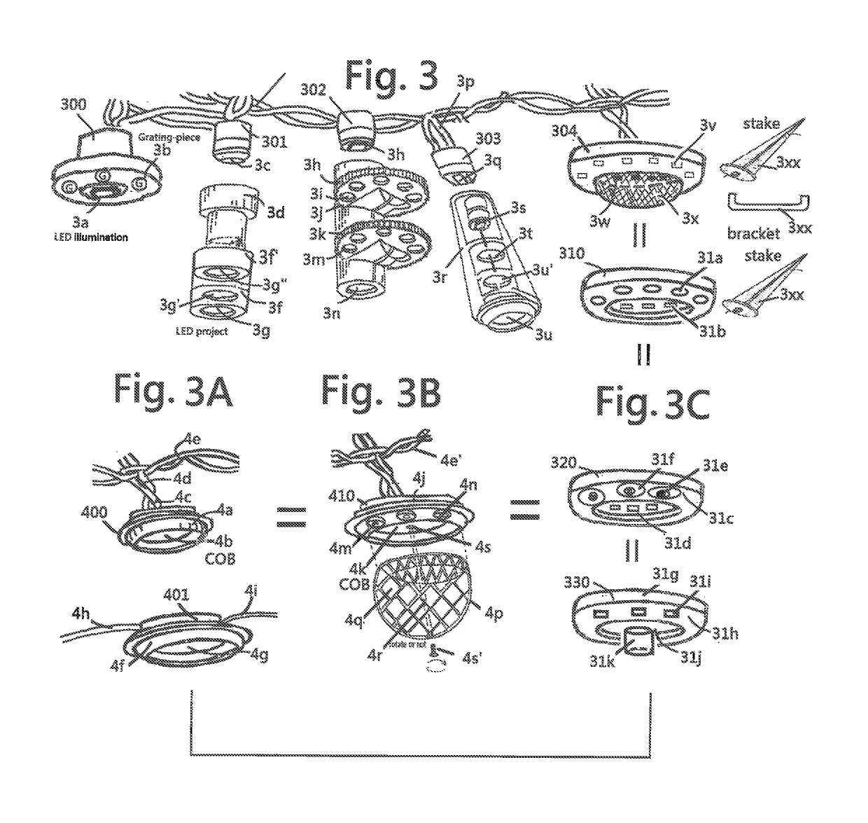

5. FIGS. 3, 3A, 3B, 3C show the 2^{nd} embodiment for laser or-and LED light source application for light string for patio, landscape, garden, building applications.

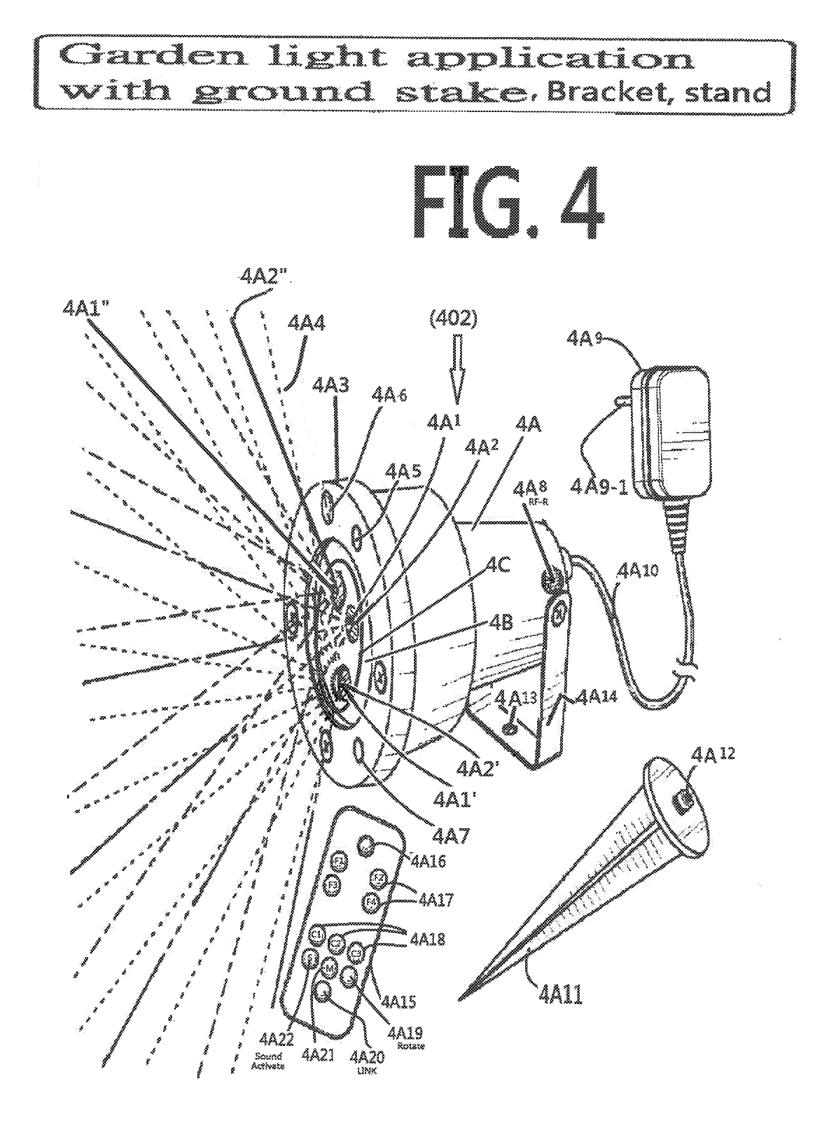

6. FIGS. 4 shown the third embodiment for laser garden light apply the more than one grating or hologram unit arranged in different level or height or apply plurality of grating or hologram film or piece inside disc or holder grating or hologram unit to get desired laser light patterns with manual or automatically adjustment-assembly including motor & gear-set, movement, push, rotate the said adjustable-assembly.

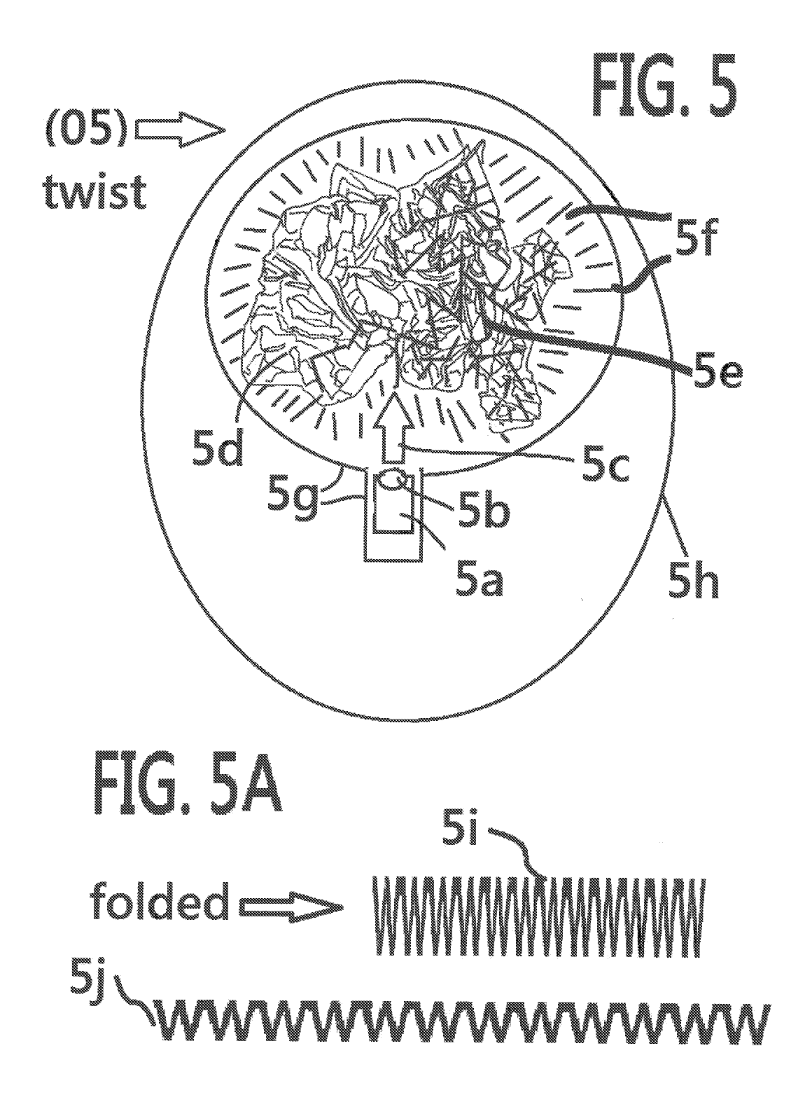

7. FIGS. 5, 5A shown the safety laser light device which has built-in coiled or folded or twisted light passable sheet, page, piece into geometric-shape or folded or coiled to let single laser light-beam to make multiple times reflection, diffusion, random reflected, refraction to plurality directions and split, divided, separated the high-power or high-wattage Laser light-beam to plurality of lower-power, lower-wattage laser light-beam emit to all directions.

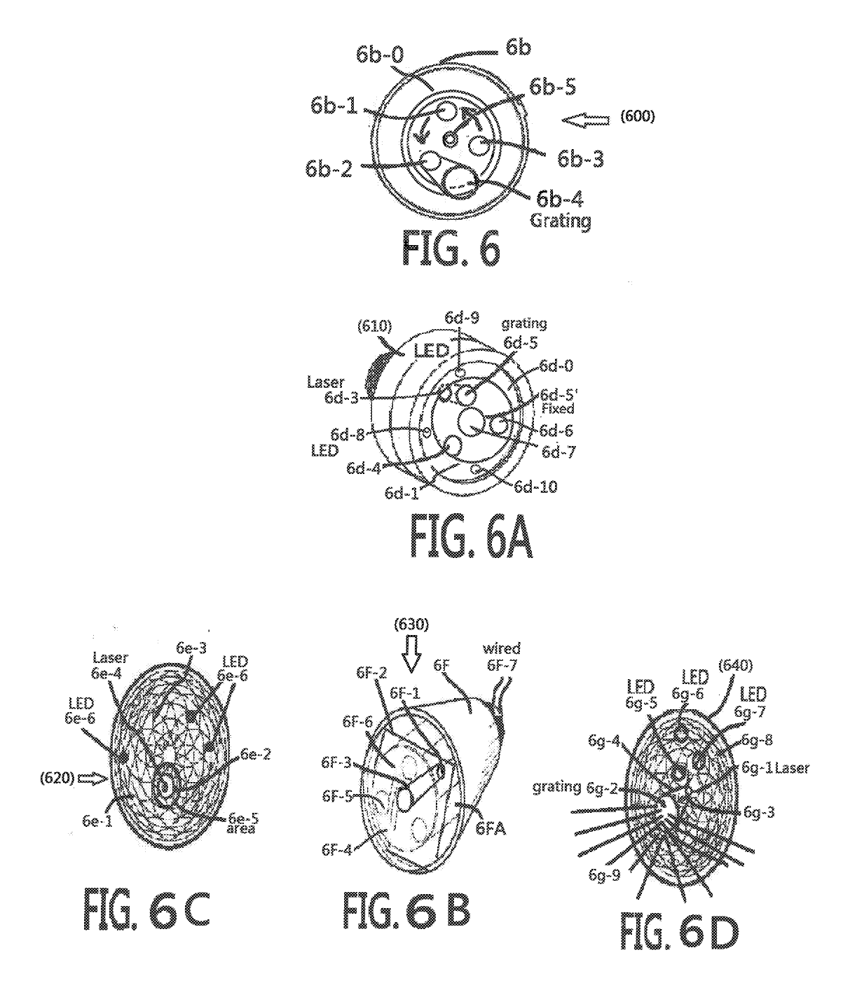

8. FIGS. 6, 6A, 6B, 6C, 6D shown some examples for garden light, bulb, desktop light, night light, light-string, landscape light string, patio light string has Laser or LED or both light source with different grating or hologram arrangement from single or multiple-layer or disc/holder grating or hologram units which has plurality of hologram or grating film, piece, glass, paper in front of laser light source with preferred LED light and other optics-lens arrangement.

### DETAILS DESCRIPTION

The current invention to make special lighted effects which has very close even brightness to make products or unit housing to be glow to be seen by viewer. The key point is use proper Laser light source with desired size of laser light-beam such as current invention preferred to have more than 5 mm diameter laser light spot light-beam which is go through some magnify optic-lens or optics-assembly to change original tiny or very small laser spot light from laser module. The sufficient or desire diameter of enlarged or original laser light beam such as 5 mm diameter emit into coiled light passable film or sheet or piece to make the 5 mm diameter sufficient laser-beam change its 5 mm spot light-beam to 360 direction with sufficient elongate length for examples 2 feet or up to 10 feet so can apply for any market required application such as sword, light pipe, light bar, stair light, patio light, power fail light, phony neon light, light guider or other geometric products with glow light effects.
The laser light beam for all market application is very worry laser light-beam will hurt people eye while people direct see the laser light-beam. However, some application use the grating film or piece or glass or injected piece to make the original single number laser light-beams to split or divided the original big wattage single light-beam to tens or hundreds or thousands number small wattage light-beam and fall within the safety wattage Laser light-beam to prevent any harm to people eyes especially for kids. Or/like co-inventor co-pending or issued patents has built-in safety-sensor device to detect people walk into safety-distance so the laser light will turn off while people fall within the safety sensor range.
The current invention consider the same risk for people eyes harm issues, so the current application is not shown the Laser light-beam emit outside to be seen by viewer. The current invention use coiled or wrapped or twisted light passable material, sheet, piece to let high power or wattage single spot laser light-beam to split or separated or divided into plurality of areas or surfaces or segments lighted-surface(s) so no more had strong and big wattage laser light-beam can be seen directly. Furthermore, the plurality of lighted area, surface, segments Is fit inner of outside housing or parts which has colored, textured, marking, painting, or other treatment to make more evenly brightness so it is much safety than traditional directly viewing the single laser light-beam or plurality of tiny laser light-beam which go through the grating or hologram film, piece, glass into tens, hundreds, thousands low-wattage or low-power split laser light-beams. This is other features.
The said coiled or wrapped or twisted into geometric shape of light passable piece, sheet, layer can make lighted areas, surfaces, segment is inside housing or parts of current inventions such as bar, ball, geometric shape for all purpose including AC or-and DC powered applications or light products for indoor or-and outdoor items which has current invention special light effects by laser light source. This is the main spirit or design, purpose for current invention.
From FIG. 1 can see one of embodiments which can be a sword (01) for star-war which has super long elongate length (15) from 1 inch to 10 feet because laser light-beam is not emit out while it traveling. The said elongated length light bar or sword or light tube applications products (01) has laser module (2) has market available tiny laser spot light-beam (1) emit out from laser module (2). In order to get the best special light effects for 1^{st} embodiment which the elongated tube is around 16 mm diameter tube or slide tube which base has 16 mm diameter and top has 14 mm diameter so easily to make more pretty shape for some application. The elongated tube or bar also can be same diameter for base or top. For some cost saving, the current invention use market available existing laser module (2) which has very tiny laser light beams such as 1 mm or 2 mm but it too small for 16 mm or 14/16 mm slide tube, so preferred to incorporated with the magnify optics-lens or optics-element to make the ½ mm diameter laser light-beam to become 5-8 mm diameter light beam but this is not limited. All other equal function, or replacement, or alternative or skill still fall within the current invention scope.
From FIG. 1 the tiny and small diameter laser light-beam (1) emit out from laser module (2) and the tiny small laser light-beam emit direction (4) to the magnify optics-lens or element (5) and magnify (6) to desire bigger spot laser light-beam (7) and bigger spot laser light-beam emit (8) to one end of inner coiled or wrapped or twisted light passable piece (13) which has edge (14) and coiled or wrapped or twisted into roll for current invention so the big spot laser light-beam (7) emit (8) to one end of light passable piece (13) so form the plurality of lighted surface, areas, layers, segments with very even brightness and emit from the outside housing (12) which has the milky or textured or colored or other treatments. This make the whole elongated length (15) glow with evenly brightness of laser light effects which is different with the LED light effect because laser light effects has like particle light properties which the LED light beam can not make. Also, LED light source because light will spread out to wider angle so it is difficult to make elongate for feet illumination, also the LED light beam can not travel long distance such as 1 feet but laser light beam can travel up to 10 or more feet for current invention.
From FIG. 2 shown the 1^{st} embodiment for elongate length milky housing laser light device. The said laser module (19) has tiny laser light source (20) which emit (21) to the optional optics-lens (22) to enlarge (23) the tiny spot laser light source (20) to desired bigger diameter laser spot light-beam (24) and emit (25) to optics-element (27) one end (26). The original spot laser light-beam (20) also can get desired bigger diameter from supplier so the optic-lens (22) is optional parts not necessary parts. The said coiled or twisted or folded or bendable optics-element(s) for different geometric housing of different laser light device is variable depend on each design.
From FIG. 2 the said coiled or twisted or folded or bendable piece (27) to separated or split or divided or wrap depend on the laser light geometric shape and application. However, all these treatment just make multiple layer, level, folded piece, twisted piece to allow the spot laser light beam to travel for multiple times to make multiple times reflection, passing through, diffusion, or other optics-properties to make the spot laser light beam become a lighted areas, surface, sections, segments to make strong spot light-beams become lighted areas, surface, section, segments inside the treated or milky or colored or textures housing (29). The coiled or twisted piece (27) preferred had one cap or cover or end-piece (28) so can easily to insert the coiled or twisted or folded piece (27) into elongate length such as 2 to 10 feet and coiled piece, sheet, film will not expend out if lack of the cap or cover or end-piece (28). It alternative or same functions or replaceable other treatment still fall within the current invention. The coiled or twisted or folded or bendable piece (27) with cap or cover (28) fit into the current example elongate length milky housing (29) which also had the sealed end or cap or cover (30) to prevent from laser light beam emit through the top of the tube housing (29).
From FIG. 2-1, show the coiled piece (27) has same length (LL) of the outside milky housing (29) and the coiled piece has width end (26″) and coiled end (26′) where allow Laser light beam emit into.
From FIGS. 2-3, 2-4, 2-5, 2-6 show the coiled piece which from FIG. 2-6 to rolled it to FIG. 2-5 to rolled it to FIG. 2-4 to rolled it to FIG. 2-3 which has similar or equivalent length (27) to fit into the Outside Housing (29).
From FIG. 2-2 assembly procedure, the Coiled piece (27) fit into the outside milky or other treatment or textured housing (29) can make strong spot laser light-beam to spread-out or split-into multiple lighted areas, surfaces, sections and go through the treated housing it become whole long elongate tube fully brightness with very close even brightness which is impossible for LED light to get for length such as 2 or more long tube because LED light source light brightness is reduce v.s. distance basing on LED still belong to radiation light source with min. emit angle around 30 degree, so a lot of light is leakage out. Laser light beam is straight and not diverse to wide area v.s. distance . . .
Also, for some special application like STAR-War movie which all shown is laser sword so need use real laser to make cool item and product. If apply LED light source will lack of the real for movie.
From the FIG. 2-2 the preferred embodiment for coiled piece to make strong spot laser light-beam split or divided or separated into lighted areas, surface, sections and go through the outside treated or textured or colored housing can get evenly brightness shown on outside housing. Same application can apply for indoor or outdoor all kind of lighting for laser light such as for patio light string which can use coiled piece (27) with laser light for patio-light string injected or assembled bulb so can become laser light patio light string.
Other application for garden light for outdoor by lower-voltage or solar power or other DC powered which same apply the coiled piece (27) with laser light source for garden light it can be instantly has laser garden light and make whole geometric shape of the outside housing such as butterfly, lamp, lantern, pagoda or others shape of garden light has good laser light effects.
Furthermore, the same skill and application to apply coiled or folded or twisted or twisted into ball or optics-elements (27) into geometric shape of outside treated or textured or colored housing (29) so can apply for the indoor or outdoor for AC powered or DC powered desk-top laser light device including but not limited such as;
1. A special light effects of laser light device (01), consist;

At least one laser light source (20) inside laser-module (19) to offer light-beam.

At least one of the optics-element (27) which is bendable, foldable piece (F1), sheet (F2), film (F3), pages (F1) has desired clearance or transparency to make laser light-beam to pass, reflect, diffusion for multiple times.

The said spot laser light-beam (20) emit into optics-element(s) (27) change the spot laser light-beam to spread, divided, split to become plurality of lighted area(s), surface(s), section(s), segment(s).

The said laser light device (01) outside housing (29) has colored, textured, finish or other treatment(s) to let the inner optics-elements lighted area(s), surface(s), section(s), segment(s) after through the said treated housing (29) to get big area, surface or elongate length has evenly brightness on outside housing (29) to be seen.
2. The special light effects of laser light device (01), the said optics-element (27) is coiled, rolled, bended, folded, twisted, twisted into geometric shape, rolled into desired length to make laser light-beam multiple times traveling.
3. The special light effects of laser light device, the said laser light-beam has desired diameter (20) to emit into the optics-element(s) (26).
4. The special light effects of laser light device, the said laser light device housing (29) is elongate length unit has the cap (28) or cover (28) or top-end (28) or wall (28) to prevent laser-light beam emit out from the top of the elongate length.
5. The special light effects of laser light device, the said laser light device treated housing (29) is a geometric shape has housing wall to prevent from inner laser lighted areas, surfaces, sections, segments direct to be seen by viewer.
6. The special light effects of laser light device, the said laser light source (20) of laser module (19) has desired color, brightness, wattage, wavelength, diameter of light-beam.
   From FIG. 2-2, It is appreciated for alternative or upgrade model for laser light device (02) which has same laser light module (31) has spot light-beam (32) which emit (33) to one or more of optics-lens (34) to change or enlarge the tiny spot laser light-beam (32) to other desire size including smaller or larger spot light-beam (35). Here is enlarge optic-lens (34) to get enlarge Spot light-beam(35) and big spot light-beams (36) emit (37) to 1^{st} grating or hologram unit (38) which has one or more of grating or hologram film or piece (38a) to form the 1^{st} laser light-pattern to show out for basic-models. If need upgrade can use disc or holder (40) which has plurality of different design grating or hologram film or piece (41)(42) (43) (44) install inside on disc or holder (40) and use automatically, or motor and gear set, or manual to change the one of plurality of grating or hologram piece (41) (42) (43) (44) to other one of (41) (42) (43) (44) so can have upgrade model. It also has alternative design which to add the 2^{nd} grating or hologram unit (39) which has desired number of grating or hologram piece (39a) on 2^{nd} grating or hologram unit (39) so can move the 2^{nd} and 1^{st} one of grating or hologram unit (39) (38) to make changing of the laser light patterns . . . This is other alternative for current invention for make steady or changeable laser patterns for indoor or outdoor all kind of lighting application. It is appreciated these concept is show on the co-inventors co-pending filing case including
   (#ZZZ-4) U.S. application Ser. No. 14/296,599 Filed on Oct. 18, 2016 which is Continue In Part filing of
   (#ZZZ-3) U.S. application Ser. No. 14/503,647 filed on Sep. 11, 2013 now is U.S. Pat. No. 9,719,654 which is Division filing of
   (#ZZZ-2) U.S. application Ser. No. 14/451,822 filed on Aug. 5, 2014, which is Continue In Part filing of
   (#ZZZ-1) U.S. application Ser. No. 14/323,318 filed on Jul. 3, 2014 which is Continue In Part filing of
   (#ZZZ-13) U.S. application Ser. No. 14/023,889 filed on Sep. 11, 2013.
   Related to the wider area image or project image night light or LED bulb or AC plug wire LED outdoor light with or without motor/spin/rotating kits for moving image.
   This filing is Division filing of
   (#QQQ-7) U.S. application Ser. No. 15/494,477 filed on Apr. 24, 2017
   which is continue in part of
   (#QQQ-6) U.S. application Ser. No. 15/355,515 filed on Nov. 18, 2016 which is continue in part of
   (#QQQ-5) U.S. application Ser. No. 15/341,782 filed on Nov. 2, 2016 which is continue in part of
   (#QQQ-4) U.S. application Ser. No. 15/348,218 filed on Nov. 10, 2016
   which is continue in part of
   (#QQQ-3) U.S. application Ser. No. 14/983,993 filed on Dec. 30, 2015
   Now is allowanced which is continue in part of
   (#QQQ-2) U.S. application Ser. No. 14/289,968 filed on May 29, 2014
   Now is U.S. Pat. No. 9,551,477 which is continue in part of
   (#QQQ-1) U.S. application Ser. No. 14/280,865 filed on May 19, 2014
   Now is U.S. Pat. No. 9,581,299 which is continue in part of
   (#QQQ-2012) U.S. application Ser. No. 13/540,728 filed on Jul. 3, 2012 now is U.S. Pat. No. 8,834,009 which is Division filed of
   (#JJJ-1) U.S. application Ser. No. 13/296,469 Filed on Nov. 15, 2011 now is U.S. Pat. No. 8,711,216

Basing on co-inventor co-pending filed case as above listed. The current invention also teached below;
7. The special light effects of laser light device, the said laser light source (20) incorporate with front optics-lens (22) or the different levels of the grating or hologram units (Not shown) to change the laser light-beam diameter or change the laser light patterns by change grating or hologram unit (not shown).
8. The special light effects of laser light device (02), the said laser light source (33) incorporated with front other optics-lens is grating or hologram units (38) or (39) or (40) which one or more piece of grating or hologram units (38) (39) which can be in one or more layer or height or levels.
9. The special light effects of laser light device (02), the said change patterns (not shown) by rotate
   (a) the one or more of grating or hologram units (38)(39) in different level or height, or
   (b) the disc or holder (40) (45) which has install plurality of the different design of gratings or hologram piece (41) (42) (43) (44).
10. The special light effects of laser light device, the said laser light device is one of AC powered device (03) by (aa) having prongs (47) to plug-in wall outlet (bb) having AC-plug wire (49) to connect with AC outlets.
11. The special light effects of laser light device, the said laser light device is one of DC powered device by

(1) having built-in batteries or energy storage device, or

(2) has built-in USB-ports (50) which only receiving outside DC power source including AC-to-DC transformer (50), or DC-to-DC from outside DC power supplier (50), or

(3) having outside DC storage device of solar module, wind power module, chemical power module.
12. The special light effects of laser light device (02), consist of;

At least one of Laser light module has laser light-source (32) to supply laser light-beam.

The said laser light device has more than one grating or hologram unit(s) (38) (38) arranged
(1) in different level or height (38) (39), or (2) in disc or holder or tray (40) with plurality of number of grating or hologram piece (41)(42) (43) (44) so can rotate or push or move from one to others;
by automatically or manual to form and adjust or change the desired laser light-patterns.
   The said Laser light device is one of indoor or outdoor applications including wall mounted night light (03), desktop light device (03), outdoor garden light (04), outdoor light string (not shown but shown co-inventor co-pending case as above list US series number), outdoor landscape light, patio light, floor light which is
   (A) AC powered device by built-in

(A-1) prong (47), or

(A-2) AC-plug wire (49)

to connect with AC outlet, or

(B) DC powered desktop device has

(B-1) USB-port to input DC power (50), or

(B-2) DC wire to get outside AC-to-DC transformer to supply DC power for desktop device.
13. The special light effects of laser light device, the said Laser light device has incorporate with at least one for optics-lens (34) (22) to enlarge the original laser light source light-beam diameter to large or smaller sizer.
14. The special light effects of laser light device, the said laser light device light-patterns is shown outside the light device unit including ceiling, wall, fence, outside building, house, ground, patio.
   It is appreciated all above discussed preferred embodiment for laser light source (21) (25) (32), optics-elements (27) for coiled or folded or bent or twisted or twisted in a ball or geometric shape, or cap, cover (28) (30) and outside treated or colored housing (29) can be any kind of equal function, alternative, or replaceable designs, constructions, assembly. All these should be still fall within the current invention claim and concept scope.
   It is appreciated the said laser light source (32) has the front enlarge optics lens 934) and pattern forming element those are grating or hologram unit (38) (39) or (40) or desired combination to make the laser lighted patterns or shapes or combinations for AC or DC powered laser light to project the lighted patterns or shape or array or matrix designs or arts to shown on indoor ceiling or walls or shown on outdoor fence, wall, garage door, building, house, garden, patio for garden light, light string, landscape light string, floor light basing on co-inventor co-pending and parent filed case on 2012 and 2013 should be 1^{st} filed case for these concept and original design which is much earlier than the above listed for Laser or LED to create the image for indoor and outdoor. It is appreciated all above discussed or mentioned co-inventor co-pending case should still fall within the current inventions scope and claim coverage.
   From FIG. 3 show the preferred embodiment for Laser or LED or both light source light string or light string with ground stake for installation which has 5 different light-units (300) (301) (302) (303) (304).
   From FIG. 3 light-unit (300) has center for LED light source (3a) to offer super bright desired color floor light or project light for night time to light the house, building, plant, tree, fence for outdoor use and connect with outlet power source by AC-Plug wire (Not shown). The said light unit (300) has one or more than one of Laser light source on the ring of the said light-unit (300) and has ring-cover (3b) as grating or hologram unit which has desired number of the holes, opening, or window (not punch through) installed the grating or hologram film, piece 6 install on the hole or opening which can be fixed and let lower level number of laser light-beam each to emit through to top each hologram or grating film or piece to form desired matrix or arrange or shaped patterns. Or/the ring-cover (3b) is rotating so can move the one of the desired grating or hologram film or piece align to lower level single laser light source for cost saving concern. This cost saving for only one lower laser light-source and rotate the ring-cover to change the top many different design or art of grating or hologram film/piece to top of only 1 laser light-source so can make laser patterns changed. For the deluxe or expensive model, the top ring (3b) has x-number of the hole(s) or opening(s) and each opening or hole has desired art or patterns of grating or hologram film/piece and align to each respectively laser light-source(s) which may for same or different color of laser light-source.
   From FIG. 3, the light unit (301) of light string for all purpose has laser light-source (3C) and top of laser light-source (301) has built-in or added-on grating or hologram unit (3d) to align with laser light-beam emit direction. The said grating or hologram unit (3d) may has desired or optional adjustable size-kit (3f′) which has optics-lens (3g″) to change the laser light-beam diameter to bigger or small diameter of laser light-beam for certain purpose or application. However, this kind of adjustable size-kit (3f′) is optional because it also can ask laser light-source supplier to make desired diameter of laser light-beam. The said grating or hologram unit (3d) for this embodiment preferred has different level or height of grating or hologram film/piece with adjustable pattern-changing kits (3f) which has 1^{st} and 2^{nd} grating or hologram film/piece (3g′)(3g) inside and use adjustable pattern-changing kits for twist or rotating to change the said 1^{st} and 2^{nd} grating or hologram film/piece related orientation, distance, position so can change the different lighted patterns.
   From FIG. 3, the light unit (302) of light string for all purpose indoor or outdoor for garden, landscape, patio for laser or LED or both light-source. The said Laser or LED or both light source (3h) emit light-beam into the said built-in or injected-together or added-on grating or hologram or project assembly as all co-pending filed (#XX-2) (#XX-1) (#II-3) (#II-4) disclosure which list above US series number.
   The grating or hologram unit (3d) has plurality of optics-lens (3i) install on the disc or holder (3j) which can use manual to move the teeth (3h) from 1^{st} optics-lens to other optics-lens to make the laser light-beam spot diameter to change size of laser light-beam. The 2^{nd} disc or holder (3k) has plurality of the grating or hologram film/piece install and can rotating to change 1^{st} grating or hologram film/piece to others one to change the laser patterns or shape. From co-pending filed case for LED projection, the said light source (3h) is LED and the 1^{st} disc is image forming unit which is film or slide or colorful printing piece such as printing on glass or plastic piece so the LED light-beam can emit into 1^{st} image forming unit and emit to 2^{nd} disc which has plurality optic-lens which for project-purpose to enlarge and spread out the lighted image out from 1^{st} disc. The grating or hologram or project assembly which may has protect-piece on top or front of the 2^{nd} disc.
   From FIG. 3, the light unit (303) which has traditional laser light device which has laser light-source (3q) and injected with or assembled with or added-on with grating or hologram unit (3r) which has magnify laser-beam diameter optics-lens (3s) and 2 levels grating or hologram unit (23t) (2u′) with front protected-piece (3u).
   From FIG. 3, the light-unit (304) which has LED light source (3w) inside the optics-lens which has texture, marking, reflective or refractive or both optics-properties to make the LED light-beam to created desired patterns or image. There has a ring-cover (304) which has many openings or holes and each one has grating or hologram film/piece installed to make the lower one or more than one laser light-source light-beam to passing through to form the laser light-beam patterns or shape and also reduce the under high-power or high-wattage laser light-beam to become plurality number or laser light-beams or laser lighted-patterns or lighted shapes to prevent from hurt people eyes while people stair looking the laser light-beam. It is appreciated it can also same as parent filed case (#XX-2010) has motion/IR/moving/Radar sensor device to detect the people approach the said laser light device within the safety distance and shot down the laser light-beam . . . Or, like the FIGS. 1 and 2 and 5 to use coiled, folded, twisted skill of the clear or transparent paper, sheet, film to have multiple times reflected, refracted, diffusion with outside housing treated or milky or colored or textured wall to make the laser light-beam become glow light effects for safety look at without need all kind of sensor help to stop emit laser light source.
   From FIG. 3, the light unit (310) is alternative combination for Laser light source light patterns or shape emit out from opening (31a) and strong color changing LED light source (31a) emit through the front desired lens (not shown) to illumination outdoor building, house, tree, plant, fence or garden items.
   From FIG. 3A, the light-unit (4a) has the wire arrangement for in-parallel and in-series so can make longer light string for Laser or LED or both light source for all purpose. The light-unit (4f) has the wire arrangement only for in parallels arrangement which can more simple make all light-unit (4f) with others in one simple wire.
   From FIG. 3B, the light-unit (410) has center LED light source (4s) emit desired color, brightness, power to front textured, treated, diamond-cut dome cover, reflective or refractive or both optics-lens in geometric shape to get design lighted patterns. It also can incorporated with the motor and gear-set device (not shown) with axis (4r) to make the front optics-lens for rotating to make desired moving patterns or image effects.
   From FIG. 3C, the light-unit (320) has center LEDs for super bright garden or landscape floor light to illuminate house, building, plant, garage door, fence, wall for outdoor garden light or light strips with optional stake (3xx) or bracket (3xx′) or like the FIG. 4. There have rotatable laser grating film/piece (31f) (31e) on the ring-cover (31c) to make the under laser light-source light-beam to passing through to form the plurality lower-power or lower-wattage image, pattern, or light-beams.
   From FIG. 3C, the light-unit (330) has laser light source with coiled or rolled transparent or clear piece (31K) to make diffusion laser light-beam inside the outer housing (not shown) to created laser soft accent light for all kind of pendent light, light for light string or other purpose as FIGS. 1 and 2 shown.
   From FIG. 4 show the Laser light device (402) has multiple color and changeable light patterns feature. The laser garden light device (402) has main housing (4A) install the circuit and laser module with multiple laser light source (4A1) (4A1′) (4A1″) and front grating film/piece (4A2) (4A2′) (4A2″) to emit the desired lighted patterns for each light source. The 3 front grating film/piece install on disc or holder (4C) which can manual or automatically or remote control for rotate (4A19) by RF remote-controller (4A15). The each of the front grating film/piece has different design, art so while rotate will change the lighted patterns or shapes. The Inside laser light-source (4A1) (4A1′) (4A1″) for different color and can select for On or Off by remote-controller (4A15) to get desired number of the colors lighted patterns or lighted shape (4A4) emit to outside for laser lighting presentation. The Ring cover (4A3) has plurality of the desire sensor (4A5) or audio-receiving (4A6) or photo-sensor (4A7) or RF-receiver (4A8) to activate the garden light or light string for all purpose for motion sensor, moving sensor, radar sensor, thermal sensor (4A5) or use sound to activate the light with optional light brightness or light changing features, or photo sensor for turn on while environment lux on certain level and turn off while environment lux up, or RF-receiver (4A8) to receive the RF-transmitter signal for selected or pre-determined functions or selection for light brightness, color, functions. The said Remote controller (4A15) has on-off button (4A16), functions selection button (4A17), color selected or mixture (4A18), remote control (4A19), RF linkable other laser light (4A20), motion, moving, radar sensor (4A21), or sound activated button (4A22).
   From FIG. 4, the said laser light for garden or light-string both can also incorporated with ground stake (4A11) or bracket base (4A14) by screw hole (4A13) or screw (4A12) to assembled together. The power source can be desired power source including AC or DC or both. The preferred for this embodiment use built-in wires to connect with outside transformer (4A9) or connect with AC-plug wire (Not shown) or USB power source (not shown) or DC battery source (not shown) or DC power bank (not shown) or DC energy storage unit for solar, wind, chemical module.
   From FIG. 5, the laser light device (05) which has laser module (5a) has laser light-source (5b) to emit the high-power or high-wattage laser light-beam (5C) into the twisted light passable clear or high-polished or high-transparent paper, film, sheet in geometric shape (5d) so can split, divided, spread to plurality of lower-power or lower-wattage light-beams (5f). The said twisted piece/sheet/film (5d) and laser module (5a) are sealed inside of a universal housing (5g) so can fit into all kind of outside housing (5h) which may have treated, texture, milky, colored, opaque or other optics properties so can block-out the inner twisted piece/film/paper (5d) all strong or brighter laser light-beam.
   From FIG. 5A, the said clear or transparent film/page/sheet folded (5i) or folded like (5j). The above discussed for preferred embodiment including coiled (16 of FIG. 1), or twisted (5d of FIG. 5), or Folded (5i or 5j of FIG. 5A) depend on different applications. Those can split or spread or divided the high-power or high-wattage laser light-beam into plurality of the patterns or image or light-beams by multiple times of reflection, or refraction, or diffusion or any combinations of optics-properties.
   From FIG. 6, show the relation of laser light-source (6b-1) (6b-2) (6b-3) with front grating piece (6b3). The laser light device is any one of applications as above discussed for indoor or outdoor lighting including but not limited for garden light, outdoor light string, patio light or patio light string, landscape light string, landscape flood light (no linkable in one string), floor light or indoor desktop lighting. The said Laser light-beam emit out surface (600) has (i) more than one of laser light-source (6b-1) (6b-2) (6b-3) install on a rotatable disc or (ii) flashing sequentially controlled by IC chip for pre-determined flashing or sequential orders from No. 1 to No. 2 to No. 3 or Reversed or random flashing or pair flashing . . . etc. as market available IC chip to control power to more than one light source all fall within the current invention.
   From FIG. 6 also show the light surface (600) has fixed position one or more of grating film/piece/sheet which allow below Laser light-source can emit light-beam through and get pre-determined lase light effects including matrix, array, shape, contour shape, plurality of light beams.
   From FIG. 6A, the said one of Laser light device (610) which can powered by bulb-base or prong or AC-plug wire to connect with AC power source. The laser light device as above listed for any kind which has not only Laser light-source (6d-3) on lower-level of surface (6d-10) and emit the laser light-beam to front rotatable multiple grating film/piece/sheet/units (6d-4) (6d-5) (6d-6) Or laser light-beam emit to the front big fixed grating film/piece/sheet/units (6d-7) to form the pre-determined laser lighted areas, array, matrix, contour, shape. Plurality of laser light-beam in single color or multiple colors to outside the surface (6d-0). The said laser light device (610) also has built-in one or more than one of LED light-source (6d-8) (6d-9) (6d-10) to emit colorful or single color LED light beam with optional front lens or film or project-assembly to make desired LED light pattern, image, projection arts or light-beam to desired outside areas, surface, building, house, garden, fence, wall, or indoor ceiling, wall, floor depend on what installation kits for the said laser and LED light device.
   From FIG. 6B, show the laser light device (630) which has wired (6F-7) to connect with AC or DC or both power source. The unit has the front protected-lens (6F-2) and has multiple of grating piece or film or sheet (6F-5) install on the rotating disc (6F-6) and disc (6f-6) is connect with axis (6F-3) from the lower position motor and gear set (not shown) to make the axis (6F-3) to rotating so let lower laser light-source (not shown) light-beam passing through one of grating film/piece/sheet of disc to form the desired moving effects of laser lighted patterns or image or contour shapes. Because the moving disc so also move the attached grating film/piece/sheet so the laser light will be changeable and variable because some time laser beam is blocked and sometime is emit out from grating film/piece/sheet.
   From FIG. 6C show the laser and LED light device (620) which has built-in Laser light source (6e-4) and front has grating piece/sheet/film align with the lower laser light-source so can created desired laser light-patterns, image, light-beam. The laser and LED light device (620) also has built-in more than one LEDs which under the front optics-cover which has desired optics-treatment, finish, optics-properties such as reflection, refraction, diffusion, textured, colored, opaque, milky color, variable thickness so can created wider viewing angle for desired LED light effects as co-pending (#ZZZ-2013) (#ZZZ-1) (#ZZZ-2) (#ZZZ-3) as above list US series number. The said grating film is under the one window of the top optics-cover (6e1) and cover has clear window (not punch through is called window) which allow laser patterns or image or plurality of lase light-beam emit out and also protect the inner grating film/piece/sheet and lower laser light-source and motor & gear-set.
   From FIG. 6D same as the FIG. 6C show the laser light device (640) has front optics-cover (6g-8) which has clear window (6g-2) and below has grating piece/film/sheet and laser light source (6g-1) emit laser high-power light beam (6g-3) to grating piece/film/sheet (under window 6g-2) make desired laser lighted pattern, image, light-beam effects (6g-9). The said laser optics-cover (6g-8) has desired optics-properties including but not limited for reflection, refraction, diffusion, variable thickness, clear window (not punch through) to make lower level LEDs (6g-5) (6g-6) (6g-7) to emit light in colors or in single color through and make desired LED light effects.
   Furthermore, The above discussed Laser light device for different wattage laser power which can have built-in safety sensor assembly such as motion-sensor, moving sensor, radar sensor, shock sensor, contactors to install inside the laser device for protect people to directly see the laser light source to harm the people eyes such as Co-inventor one or parent filed case (#XX-1) has motion or moving detector or radar sensor to detect people within the safety-range or not? If any people get into or within the safety detector range, The laser light device will turn off until the safety sensor range has no any motion, moving, heat been detected for a pre-determined time period.
   For example, The said Laser night light has laser light-source to emit the desired laser lighted patterns to outside surface such as ceiling or walls or house or garden has desired sensor or detector to sensor or detect people fall within the safety-range. While people fall within the night light for desktop or plug-in will turn off at one for period of time and back to normal work.
   For examples, the Said laser night light has power fail functions, and can take out from wall outlets for laser portable light and powered by backup batteries. While the night light had impact or shock been sensor, the night light will shut-off at once. Or, while the people move out from outlet, the laser light-source will drop to lower wattage or power so reduce the laser light source to safety range such as 0.05 Watt and front has grating piece to split the 0.05 Watt to Tens or hundreds of lower power light-beam. Or other market skill to sensor pre-determined condition and stop or reduce or lower the laser light source to prevent any harm to people eyes while people stair the laser light-beam.
   It is appreciate the all above list and discuss text and co-inventor co-pending concept, idea, construction, arrangement for laser or-and LED light source with different arrange of optic-lens, transparent sheet/piece/page with coiled, rolled, wrapped, twisted, folded to make single or multiple hi-power or hi-wattage laser-beam to split, divide, reflected, refracted, diffused to lighted areas, surface, segment, section go through outside treated or textured or colored or sandblasted or milky housing to become a laser glow light is 1^{st} of the current features of invention.
   It also appreciated the all above list and discussed and co-inventor co-pending concept, idea, construction, arrangement for laser or-and LED light device has more than one light source arranged to pass through

a. Different level grating-units has desired grating or hologram piece/film/sheet, or-and

b. Plurality of different grating or hologram piece/film/sheet installed within disc or holder with fixed or rotating assembly to change the laser lighted patterns, image, light-beams.

c. Optics-lens or slide or film or treated or textured or reflective or refractive or diffusion optics-element to to make desired LED lighted patterns, image incorporated with laser light source predetermined laser light effects.

1. A special light effects of laser light device, consist;
At least one laser light source inside laser-module to offer light-beam.
At least one of the optics-element which is one of bendable, foldable piece, sheet, film, pages with desired clearance or transparency to make laser light-beam to pass, reflect, diffusion for multiple times.
The said spot laser light-beam emit into optics-element(s) change the spot laser light-beam to spread, divided, split to become plurality of lighted area(s), surface(s), section(s), segment(s), light-beam.
The said laser light device outside housing has colored, textured, finish or other treatment(s) to let the inner optics-elements lighted area(s), surface(s), section(s), segment(s), light-beam after through the said treated housing to get big area, surface or elongate length has evenly brightness on outside housing to be seen.

2. The special light effects of laser light device as claim 1, the said optics-element is coiled, rolled, bended, folded, twisted, twisted into geometric shape, rolled into desired length to let laser light-beam travel for multiple times.

3. The special light effects of laser light device as claim 1, the said the spot light-beam has desired diameter to emit into the optics-element(s).

4. The special light effects of laser light device as claim 1, the said laser light device housing is one of elongate length unit has the cap or cover or top-end or wall to prevent laser-light beam emit out from the top or front of the elongate length.

5. The special light effects of laser light device as claim 1, the said laser light device treated housing is a geometric shape has housing wall to prevent from inner laser lighted areas, surfaces, sections, segments, light-beam direct to be seen by viewer.

6. The special light effects of laser light device as claim 1, the said laser light source has desired color, brightness, wattage, wavelength, diameter of light-beam.

7. The special light effects of laser light device as claim 1, the said laser light source incorporate with front optics-lens or optics-lens-assembly to change the laser spot light-beam diameter.

8. The special light effects of laser light device as claim 1, the said laser light source incorporated with front other optic-lens or optics-lens-assembly which is one or more piece of grating or hologram units which can be in one or more layer or height or levels.

9. The special light effects of laser light device as claim 1, the said laser light-beam can change patterns by rotate
(a) the one or more of grating or hologram units in different level or height, or
(b) the disc or holder which has install plurality of the different design of gratings or hologram units.

10. The special light effects of laser light device as claim 1, the said laser light device is one of AC powered device by (1) having prongs to plug-in wall outlet (2) having AC-plug wire to connect with AC outlets.

11. The special light effects of laser light device as claim 1, the said laser light device is one of DC powered device
(1) has built-in batteries or energy storage device, or
(2) has built-in USB-ports or connectors or receiving-end(s) which receiving outside DC power from AC-to-DC, or DC-to-DC circuit device including transformer, USB power bank, or
(3) outside DC storage unit incorporate with solar module, wind power module, chemical power module.

12. The special light effects of laser light device, consist of;
At least one of Laser light module has laser light-source to supply laser light-beam.
The said laser light device has more than one grating or hologram unit(s) arrange
(1) in different level or height to, or
(2) in disc or holder or tray with plurality of number of grating or hologram-piece; so can rotate or push or pull or move the said one grating or hologram-piece by automatically or manual to form and adjust or change the relative orientation, position, location to get desired laser light-patterns.
The said Laser light device is one of indoor or outdoor applications including wall mounted night light, desktop light device, outdoor garden light, outdoor light string, outdoor landscape light, patio light, floor light which is
(A) AC powered device by built-in
(A-1) prong, or
(A-2) AC-plug wire
to connect with AC outlet, or-and
(B) DC powered desktop device has
(B-1) USB-port to input DC power, or
(B-2) DC wire to get outside AC-to-DC or DC-to-DC device to supply the DC current for desktop device.

13. The special light effects of laser light device as claim 12, the said Laser light device has incorporate with at least one for optics-lens to enlarge the original spot laser light source light-beam diameter to large or smaller sizer diameter.

14. The special light effects of laser light device as claim 12, the said laser light device light-patterns is shown outside the light device including ceiling, wall, fence, outside building, house, ground, patio.

15. The special light effects of laser light device as claim 12, the said laser light device has built-in sensor selected from PIR motion sensor, moving detector, radar sensor, photo sensor, shock sensor, break sensor, sound sensor.

16. The special light effects of laser light device as claim 12, the said laser light device has Time delay circuit or timer to turn on and turn-off the laser light source for pre-determined, time, time period or both.

17. The special light effects of laser light device as claim 12, the said laser light device incorporate with LED light device which is one of floor light, garden light, light strips, LED landscape light string, LED motion sensor light, LED security light which has motion, radar, moving sensor or detector, or has RF transmitter or RF receiver, or has wireless control system.

18. The special light effects of laser light device as claim 12, the said laser light device incorporate with LED light device has reflective, refractive, diffusing, or any desired combination for these functions for 1^{st} or 2^{nd} or both optic-lens to get the desired functions.
